(19) United States
(12) Patent Application Publication
(10) Pub. No.: US 2025/0167339 A1
(43) Pub. Date: May 22, 2025

(54) COMPOSITE GRAPHENE-ALUMINUM BATTERY PACK COOLING PLATES

(71) Applicant: GM Global Technology Operations LLC, Detroit, MI (US)

(72) Inventors: Yi Liu, Troy, MI (US); Qigui Wang, Rochester Hills, MI (US); Kestutis A. Sonta, Troy, MI (US); Ronald C. Daul, Northville, MI (US); Ali Shabbir, Sterling Heights, MI (US)

(21) Appl. No.: 18/513,746

(22) Filed: Nov. 20, 2023

(51) Int. Cl. H01M 10/6554; H01M 10/613; H01M 10/625; H01M 10/647; H01M 10/6568

(52) U.S. Cl. CPC H01M 10/6554; H01M 10/613; H01M 10/625; H01M 10/647; H01M 10/6568; H01M 2220/20

(57) ABSTRACT

A battery pack assembly includes a battery pack enclosure, a first cooling plate, a plurality of battery cells, and a plurality of second cooling plates. The first cooling plate is supported by the floor within the battery pack enclosure, and the first cooling plate is formed of graphene aluminum composite. The plurality of battery cells is supported by the first cooling plate, and the first cooling plate is disposed between the floor of the battery pack enclosure and the plurality of battery cells. The second cooling plates are disposed between each of the battery cells, and the second cooling plates are formed from graphene aluminum composite.

### INTRODUCTION

The present disclosure relates to the field of composite powders and, more particularly, to cooling plates formed of a composite graphene-aluminum powder and systems and methods for producing and using the graphene-aluminum powder in additive manufacturing or traditional powder metallurgy processes.

Aluminum and aluminum alloy materials are used as thermal conductors in many components, such as in electric vehicle battery pack components. Batteries and other vehicle components create heat within vehicle battery packs, which must be removed to prevent overheating. Additionally, the battery pack components are subject to stresses and must be structurally sound. Furthermore, the battery pack components, when including aluminum and aluminum alloys, are subject to grain growth at increased operating temperatures (50° C.-100° C.) when subjected to long term operation.

While current aluminum and aluminum alloy components achieve their intended purpose of being thermally conductive and providing structural strength and stability, there is a need for vehicle battery pack components and methods and systems for making the components that have increased thermal conductivity, structural strength, and material stability.

### SUMMARY

According to several aspects of the present disclosure, a battery pack assembly is provided. The battery pack assembly includes a battery pack enclosure, a first cooling plate, a plurality of battery cells, and a plurality of second cooling plates. The battery pack enclosure includes a floor and a plurality of side walls. The first cooling plate is supported by the floor within the battery pack enclosure, and the first cooling plate is formed of graphene aluminum composite. The first cooling plate includes a first planar wall and a second planar wall, a first coolant inlet port and a first coolant outlet port, a first coolant volume, and at least one first coolant flow path. The first coolant inlet port and the first coolant outlet port are disposed along an edge of the first planar wall and the second planar wall, and the first coolant volume is defined by the first planar wall and the second planar wall. The first coolant flow path is defined by and extends through the first coolant volume between the first coolant inlet port and the first coolant outlet port. The plurality of battery cells is supported by the first cooling plate, and the first cooling plate is disposed between the floor of the battery pack enclosure and the plurality of battery cells. The second cooling plates are disposed between each of the battery cells, and the second cooling plates are formed from graphene aluminum composite. Each of the plurality of second cooling plates includes a third planar wall and a fourth planar wall, a second coolant inlet port and a second coolant outlet port, a second coolant volume, and a second coolant flow path. The second coolant inlet port and the second coolant outlet port are disposed along an edge of the third planar wall and the fourth planar wall. The second coolant volume is defined by the third planar wall and the fourth planar wall. The second coolant flow path extends through the second coolant volume between the second coolant inlet port and the second coolant outlet port.

In accordance with another aspect of the disclosure, the battery pack assembly includes a first coolant flow path extending through the first cooling plate in a serpentine configuration.

In accordance with another aspect of the disclosure, the battery pack assembly includes battery cells including at least one prismatic battery cell.

In accordance with another aspect of the disclosure, the battery pack assembly includes battery cells oriented perpendicular to the first cooling plate.

In accordance with another aspect of the disclosure, the battery pack assembly includes second cooling plates that are between 0.5 and 5 millimeters in thickness.

In accordance with another aspect of the disclosure, the battery pack assembly includes second cooling plates that are oriented perpendicular to the first cooling plate.

According to several aspects of the present disclosure, a method is provided. The method includes a first step of providing an inert environment. The method includes a second step of introducing a first mist to the inert environment, and the first mist is atomized aluminum with a negative charge. The method includes a third step of introducing a second mist to the inert environment, and the second mist includes graphene flakes with a positive charge. The method includes a fourth step of mixing the first mist and the second mist within the inert environment to produce a graphene-aluminum composite powder.

In accordance with another aspect of the disclosure, the method includes separating the graphene-aluminum composite powder into fractions within the inert environment using mesh screens.

In accordance with another aspect of the disclosure, the method includes feeding a first fraction of the fractions into an additive manufacturing device coupled to the inert environment.

In accordance with another aspect of the disclosure, the method includes a first mist formed from aluminum melt and fed into the inert environment through a high-pressure nozzle.

In accordance with another aspect of the disclosure, the method includes a process pressure of the inert environment that includes a vacuum.

In accordance with another aspect of the disclosure, the method includes aluminum particles of the graphene-aluminum composite powder that are aluminum nanoparticles.

In accordance with another aspect of the disclosure, the method includes graphene flakes formed via electrochemical exfoliation.

In accordance with another aspect of the disclosure, the method includes forming a graphene-aluminum composite first cooling plate and a graphene-aluminum composite second cooling plate using at least one of additive manufacturing or a powder metallurgy process.

In accordance with another aspect of the disclosure, a graphene-aluminum composite powder is formed by the above method.

According to several aspects of the present disclosure, a system is provided. The system includes a chamber containing an inert environment and a mixing portion within the inert environment. The system also includes a first nozzle and a second nozzle. The first nozzle introduces a first mist of atomized aluminum having a negative charge into the mixing portion of the inert environment. The second nozzle introduces a second mist of graphene flakes having a positive charge into the mixing portion of the inert environment. Further, the system includes an output configured to convey a graphene-aluminum composite powder from the inert environment. The system forms graphene-aluminum composite powder from mixing the first mist of negatively charged atomized aluminum and the second mist of positively charged graphene flakes.

In accordance with another aspect of the disclosure, the system includes a first nozzle that is a high-pressure nozzle.

In accordance with another aspect of the disclosure, aluminum particles of the graphene-aluminum composite powder include aluminum nanoparticles.

In accordance with another aspect of the disclosure, the system includes at least one mesh screen configured to separate the graphene-aluminum composite powder into a plurality of fractions within the inert environment.

In accordance with another aspect of the disclosure, the system includes a forming device configured to form at least one of a graphene-aluminum composite first cooling plate or a graphene-aluminum composite second cooling plate using at least one of an additive manufacturing or a powder metallurgy process.

### BRIEF DESCRIPTION OF THE DRAWINGS

The drawings described herein are for illustration purposes only and are not intended to limit the scope of the present disclosure in any way.

FIG. 1 is a perspective view illustrating a vehicle having a battery pack assembly, in accordance with the present disclosure.

FIG. 2 is a perspective view illustrating the battery pack assembly shown in FIG. 1 including a first cooling plate formed of a graphene-aluminum composite, in accordance with the present disclosure.

FIG. 3 is an exploded perspective view illustrating the first cooling plate shown in FIG. 2, in accordance with the present disclosure.

FIG. 4A is a side perspective view illustrating a plurality of second cooling plates coupled to the first cooling plate shown in FIGS. 2 and 3, in accordance with the present disclosure.

FIG. 4B is an exploded perspective view illustrating one second cooling plate shown in FIG. 4A, in accordance with the present disclosure.

FIG. 5 is a schematic view of a system for producing a graphene aluminum composite powder for forming the first cooling plate and second cooling plates shown in FIGS. 2 through 4B, in accordance with the present disclosure.

FIG. 6 is a molecular view of the graphene-aluminum composite powder used to form the first cooling plate and second cooling plates shown in FIGS. 2 through 4B, in accordance with the present disclosure.

FIG. 7 is a flowchart illustrating a method of forming the graphene-aluminum composite powder using the system shown in FIG. 6, in accordance with the present disclosure.

FIG. 8 is a schematic view illustrating an additive manufacturing device for manufacturing the first cooling plate and second cooling plates shown in FIGS. 2 through 4B using the graphene-aluminum composite powder shown in FIG. 6.

FIG. 9 is a flowchart illustrating a method for producing the first cooling plate and second cooling plates shown in FIGS. 2 through 4B using the additive manufacturing device shown in FIG. 8.

### DETAILED DESCRIPTION

The following description is merely exemplary in nature and is not intended to limit the present disclosure, application, or uses.

Referring to FIG. 1, a vehicle 10 having a battery pack assembly 12 is shown, according to the principles of the present disclosure. The battery pack assembly 12 provides motive power to the vehicle 10. The battery pack assembly 12 is illustrated with an exemplary vehicle 10, and the vehicle 10 is an electric vehicle or hybrid vehicle having wheels 14 driven by an electric vehicle motor (not shown). While the vehicle 10 is illustrated as a passenger road vehicle, it should be appreciated that the battery pack assembly 12 may be used with various other types of vehicles. For example, the battery pack assembly 12 may be used in nautical vehicles, for example boats, or aeronautical vehicles, for example drones or passenger airplanes. Moreover, the battery pack assembly 12 may be used as a stationary power source separate and independent from a vehicle.

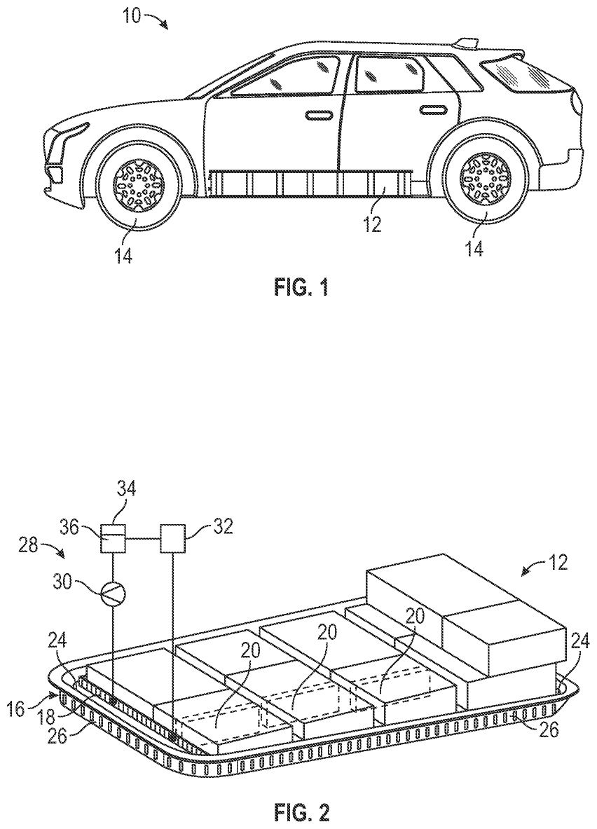

Referring now to FIG. 2, a perspective view of the battery pack assembly 12 is shown and generally includes a battery pack enclosure 16, a first cooling plate 18, a plurality of battery cells 20, and a plurality of second cooling plates 22. The battery pack enclosure 16 generally includes a floor 24 and a plurality of side walls 26. The plurality of side walls 26 extend around a periphery of the floor 24. The floor 24 is a generally planar member and is supported by and mounted to the vehicle 10 using mechanical fasteners (not shown) such as bolts or the like threaded through apertures in the floor 24. Additionally, the battery pack enclosure 16 may include a top cover (not shown) coupled to the plurality of side walls 26.

With continuing reference to FIG. 2, the first cooling plate 18 is supported by the floor 24 of the battery pack enclosure 16. The first cooling plate 18 regulates temperature of the battery pack enclosure 16 by removing heat dissipated from batteries or other heat-producing devices and transferred to the first cooling plate 18. The first cooling plate 18 forms part of a battery pack enclosure 16 thermal management system 28 that generally includes a pump 30, a heat exchanger 32, and a coolant reservoir 34. The thermal management system 28 may include various other components including temperature and humidity sensors, valves, and electronic controllers without departing from the scope of the present disclosure. Generally, the pump 30 is in fluid communication with the coolant reservoir 34 and pumps coolant 36 from the coolant reservoir 34 to the first cooling plate 18. The coolant 36 is subsequently returned from the first cooling plate 18 and communicated to the heat exchanger 32, which removes heat from the coolant 36, for example using a liquid to air heat exchanger with a fan, although other types of heat exchangers may be employed. The coolant 36 is then returned to the coolant reservoir 34.

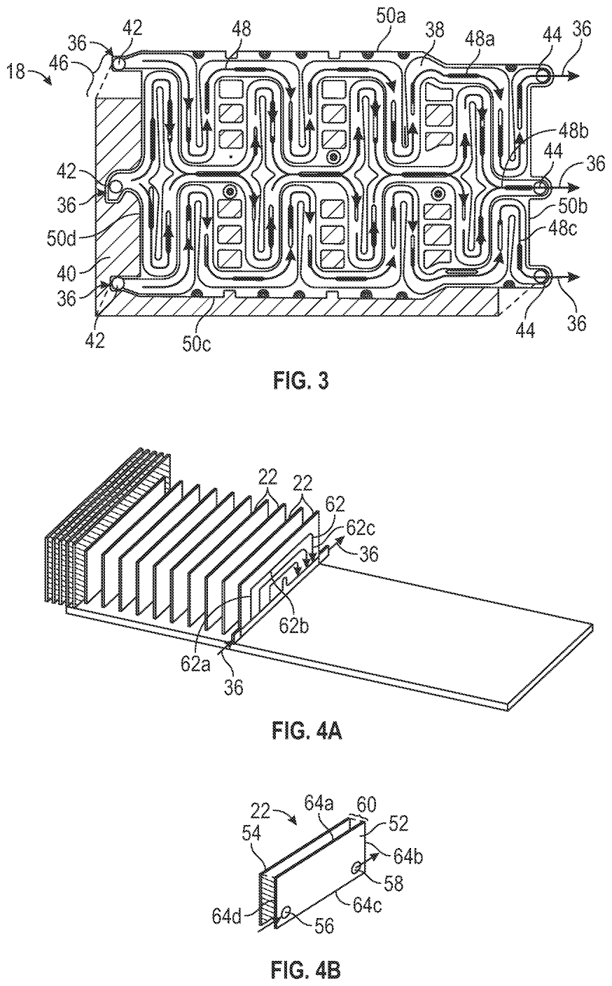

FIG. 3 illustrates an exploded perspective view of the first cooling plate 18. The first cooling plate 18 is formed from a graphene aluminum composite and includes a first planar wall 38 and a second planar wall 40, a first coolant inlet port 42, a first coolant outlet port 44, a first coolant volume 46, and at least one first coolant flow path 48. The first planar wall 38 and the second planar wall 40 are coupled together and generally have a rectangular or square shape defining four edges 50a, 50b, 50c, 50d of the first cooling plate 18. The first planar wall 38 and the second planar wall 40 are proximate to and conduct heat from batteries and other heat producing devices within the battery pack assembly 12.

The first coolant inlet port 42 and the first coolant outlet port 44 are arranged along an edge 50a, 50b, 50c, 50d of the first cooling plate 18. As illustrated in FIG. 2, the first coolant inlet port 42 and first coolant outlet port 44 are in fluid communication with the pump 30, the heat exchanger 32, and the coolant reservoir 34. The first coolant inlet port 42 is configured to receive coolant 36 from the thermal management system 28, and the first coolant outlet port 44 is configured to return coolant 36 to the thermal management system 28. It should be appreciated that the first cooling plate 18 can include a plurality of first coolant inlet ports 42 and/or first coolant outlet ports 44.

With continuing reference to FIG. 3, the first coolant volume 46 is defined by the first planar wall 38 and the second planar wall 40. The first coolant volume 46 is configured to contain coolant 36, which provides a convective cooling effect to the first planar wall 38 and the second planar wall 40. The first coolant flow path 48 is defined by and extends through the first coolant volume 46 between the first coolant inlet port 42 and the first coolant outlet port 44. Shown in FIG. 3, the first coolant flow path 48 can be in a serpentine configuration. However, it will be appreciated that the first coolant flow path 48 can be in other configurations, for example a linear configuration. Additionally, the first coolant volume 46 can include a plurality of first coolant flow paths 48, for example three first coolant paths 48a, 48b, 48c as depicted in FIG. 3.

Referring again to FIG. 2, the plurality of battery cells 20 is supported by the first cooling plate 18. The first cooling plate 18 provides cooling to the plurality of battery cells 20 via heat transfer. The battery cells 20 are preferably prismatic battery cells whose chemistry is enclosed in a rigid, rectangular casing. The rectangular casing allows for efficient stacking of the battery cells 20. However, it should be appreciated that any type of battery cell 20 may be employed so long as the battery cell 20 is compatible with the battery pack assembly 12, for example cylindrical lithium-ion battery cells or pouch cells. Additionally, the plurality of battery cells 20 are illustrated oriented perpendicular to the first cooling plate 18. However, it should be appreciated that the plurality of battery cells 20 can be arranged in other orientations so long as the battery cells 20 are supported by the first cooling plate 18.

FIG. 4A illustrates a perspective view of the plurality of second cooling plates 22. The second cooling plates 22 are disposed between each of the plurality of battery cells 20. In the example shown in FIG. 4A, the second cooling plates 22 are disposed on and fluidly communicate with the first cooling plate 18. For illustration purposes only, a portion of the second cooling plates 22 are shown not between battery cells 20. The second cooling plates 22 are configured to circulate coolant 36 therethrough to provide cooling to the battery cells 20 via heat transfer. Each of the second cooling plates 22 is formed from graphene aluminum composite and can be of varying thickness (e.g., 0.5 millimeter, one millimeter, two millimeters, five millimeters, and so forth). In the example illustrated in FIG. 4A, each second cooling plate 22 is oriented perpendicular to the first cooling plate 18. However, it will be appreciated that the second cooling plates 22 can be configured in other orientations so long as the second cooling plates 22 are disposed between the battery cells 20. Shown in FIGS. 4A and 4B, each of the second cooling plates 22 includes a third planar wall 52 and a fourth planar wall 54, a second coolant inlet port 56 and a second coolant outlet port 58, a second coolant volume 60, and at least one second coolant flow path 62.

With continuing reference to FIGS. 4A and 4B, the third planar wall 52 and the fourth planar wall 54 are coupled together and generally have a rectangular or square shape. The third planar wall 52 and fourth planar wall 54 define four edges 64a, 64b, 64c, 64d of the second cooling plate 22. The third planar wall 52 and the fourth planar wall 54 abut and are proximate to and conduct heat from the battery cells 20 and other heat producing devices within the battery pack assembly 12.

The second coolant inlet port 56 and the second coolant outlet port 58 are arranged along an edge 64a, 64b, 64c, 64d of the second cooling plate 22. As illustrated in FIG. 4A, the second coolant inlet port 56 and second coolant outlet port 58 are in fluid communication with the pump 30, the heat exchanger 32, and/or the coolant reservoir 34 via the first cooling plate 18. It should be appreciated that the second cooling plate 22 can be in fluid communication with the pump 30, the heat exchanger 32, and/or the coolant reservoir 34 in other ways (e.g., the second cooling plate 22 can be in direct communication with the pump 30, the heat exchanger 32, and/or the coolant reservoir 34 via hoses, tubing, and the like). The second coolant inlet port 56 is configured to receive coolant 36 from the first cooling plate 18, and the second coolant outlet port 58 is configured to return coolant 36 to the first cooling plate 18, the pump 30, the heat exchanger 32, and/or the coolant reservoir 34.

Still referring to FIG. 4, the second coolant volume 60 is defined by the third planar wall 52 and the fourth planar wall 54. The second coolant volume is configured to contain coolant 36, which provides a convective cooling effect to the second cooling plates 22. The second coolant flow path 62 is defined by and extends through the second coolant volume 60 between the second coolant inlet port 56 and the second coolant outlet port 58. Shown in FIG. 3, the second coolant flow path 62 can be in a generally piecewise linear configuration, with a series of consecutively arranged segments 62a, 62b, 62c. It will be appreciated that the second coolant flow path 62 can be in other configurations (e.g., a serpentine configuration). Additionally, the second coolant volume 60 can include a plurality of second coolant flow paths 62, for example four second coolant paths as shown in FIG. 4A. The first cooling plate 18 and the plurality of second cooling plates 22 can be formed using the system and methods and with the graphene aluminum composite powder discussed in more detail below.

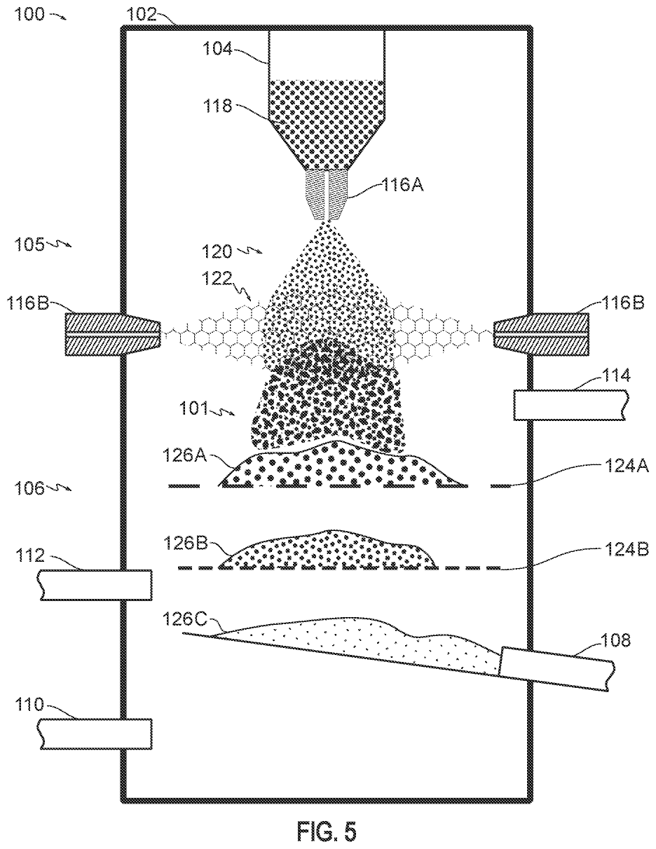

FIG. 5 illustrates an example system 100 for producing a graphene-aluminum composite powder 101. The system includes a chamber 102, an aluminum feedstock 104, a graphene feedstock (not shown), a mixing portion 105, a separation portion 106, and a graphene-aluminum composite powder output 108. The chamber 102 includes an inert environment therein that may be conditioned using a vacuum source 110, an inert gas inlet 112, and inert gas outlet 114, as well as temperature regulation devices (not shown).

The vacuum source 110 is configured to evacuate air from the inert environment during startup. The vacuum source 110, or another vacuum source, may be further configured to maintain the inert environment at a desired process pressure either alone or in combination with other devices.

An inert gas flows through the system 100 to inhibit oxidation of the powder and particles thereof. The inert gas enters the chamber 102 via inert gas inlet 112 and exits the chamber 102 via inert gas outlet 114. The flow of the inert gas may be further configured to affect or to produce desired gas-flow patterns within the system 100. For example, the inert gas inlet 112 may be located below the separation portion 106 and the inert gas outlet 114 may be located above the separation portion 106 such that the flow of the inert gas promotes agitation of the graphene-aluminum composite powder 101 to aid in separation of the graphene-aluminum composite powder 101 by size (e.g., by promoting fluidization of the graphene-aluminum composite powder 101).

The temperature regulation devices are configured to heat and/or cool the inert environment to a desired temperature profile. The temperature profile may be a uniform temperature, a plurality of regions with different temperatures, a temperature gradient, combinations thereof, or the like. In some aspects, the temperature profile is produced by controlling temperatures of the feedstocks, spacing of components, and insulation or thermal conductivity of the system chamber 102.

Aluminum and graphene are fed into the mixing portion 105 of the system 100 through respective spray nozzles 116A, 116B. The aluminum and graphene are fed with opposing charges. Beneficially, while not being bound by theory, it is believed that providing the feeds as oppositely charged particles enhances both contact between the aluminum particles and graphene flakes and packing of the resultant graphene-aluminum composite powder 101. In one example, the nozzles 116A, 116B may include one or more high-pressure nozzles. Additionally, or alternatively, the nozzles 116A, 116B may include one or more electrospray nozzles.

Moreover, the amount of charge imparted on the particles is selected to reduce voids in the resultant powder and parts formed therefrom. For example, only a portion of the aluminum particles may be charged such that the charged particles are attracted to the graphene flakes while the uncharged particles reduce repulsive forces that may leave voids in a resultant powder or additive manufacturing process. Any residual charges can be removed by grounding after mixing (e.g., by grounding mesh screens 124A, 124B).

With continuing reference to FIG. 5, a first nozzle 116A is coupled to the aluminum feedstock 104, for example a deoxidized aluminum melt 118. The first nozzle 116A is configured to produce a negatively charged atomized aluminum mist 120 with a desired particle size distribution. In an example, the aluminum particles within the atomized aluminum mist 120 may be nanoparticles. In some instances, the diameter of the aluminum particles is approximately the lateral flake size of the graphene particles, which provides enhanced aluminum-aluminum interfaces. In other instances, the diameter of the aluminum particles is an order of magnitude less than the lateral flake size of the graphene particles, which provides enhanced aluminum-aluminum and graphene-aluminum interfaces. In further instances, the diameter of the aluminum particles is two orders of magnitude less than the lateral flake size of the graphene particles, which provides enhanced graphene-aluminum interfaces.

A second nozzle 116B is coupled to the graphene feed stock. The second nozzle 116B is configured to produce a positively charged graphene mist 122. The graphene feed stock includes pristine graphene flakes in a solvent. The graphene flakes are sized to provide desired mechanical, electrical conductivity, and/or thermal conductivity properties of resulting graphene-aluminum composite parts. The graphene flakes can be single-layer graphene flakes and/or few-layer graphene flakes. In some instances, the graphene flakes are formed via electrochemical exfoliation techniques. In one example, the average lateral diameter of graphene flakes is between 10 nm and 10 μm.

The solvent is selected to avoid negative interactions with the aluminum mist 120. For example, the solvent is selected to avoid oxidizing the aluminum particles, flocking the aluminum particles, or producing an undesirable shape to the aluminum particles. The solvent is also selected not to be present in the resultant powder under process conditions. The solvent may be or include polar solvents like alcohols (e.g., methanol or ethanol) and/or nonpolar solvents like medium- to long-chain hydrocarbons (e.g., gasoline or kerosene).

The aluminum mist 120 and graphene mist 122 are combined in the mixing portion 105 of the inert environment. The mixing portion 105 is designed to produce a homogenous mixture of the two mists. For example, the nozzles 116A, 116B may be distributed about the mixing portion 105 such that turbulation from the sprayed mists provides for homogenous mixing of the aluminum particles and graphene flakes. Additionally, or alternatively, flow of the inert gas may be controlled to enhance mixing of the mists. For example, mixing may be enhanced by selecting positions of the inert gas inlet 112 and inert gas outlet 114, flowrate of the inert gas, positioning of flow-control features (e.g., baffles, shapers, and turbulators), combinations thereof, and the like.

After the two mists have homogenously mixed, the graphene-aluminum composite powder 101 settles to the separation portion 106 of the inert environment. The separation portion 106 can include, for example, a plurality of mesh screens 124A, 124B. The mesh screens 124A, 124B are arranged such that the graphene-aluminum composite powder 101 is filtered by a first mesh screen 124A that has larger aperture sizes than a subsequent mesh screen 124B such that the graphene-aluminum composite powder 101 is separated into a plurality of fractions 126A, 126B, 126C having known and unique particle size distributions. Each of the plurality of fractions 126A, 126B, 126C may be selected for a respective use. For example, one of the fractions 126C may be selected for an additive manufacturing process, another of the fractions 126B may be further processed for another use, and another of the fractions 126A may be processed to remove contaminants and recycled into the aluminum melt 118.

In some examples, the graphene-aluminum composite powder 101 and/or a particular one or more of the fractions 126A, 126B, 126C are between 1 wt. % and 40 wt. % graphene. In further examples, the graphene-aluminum composite powder 101 and/or a particular one or more of the fractions 126A, 126B, 126C are between 0.001 vol. % (volume fraction) and 30 vol. % graphene. In further examples, the graphene-aluminum composite powder 101 and/or a particular one or more of the fractions 126A, 126B, 126C are between 10 vol. % and 20 vol. % graphene. Beneficially, optimized tensile strength and electrical properties may be obtained with a composite graphene-aluminum composite powder having graphene flakes with an average lateral flake diameter of 2 μm and loading of 10 vol. %, an average lateral flake diameter of 5 μm and loading of 15 vol. %, or an average lateral flake diameter of 7 μm and loading of 20 vol. %. Beneficially, reducing average lateral flake diameter generally reduces an amount of graphene needed in the resulting powder.

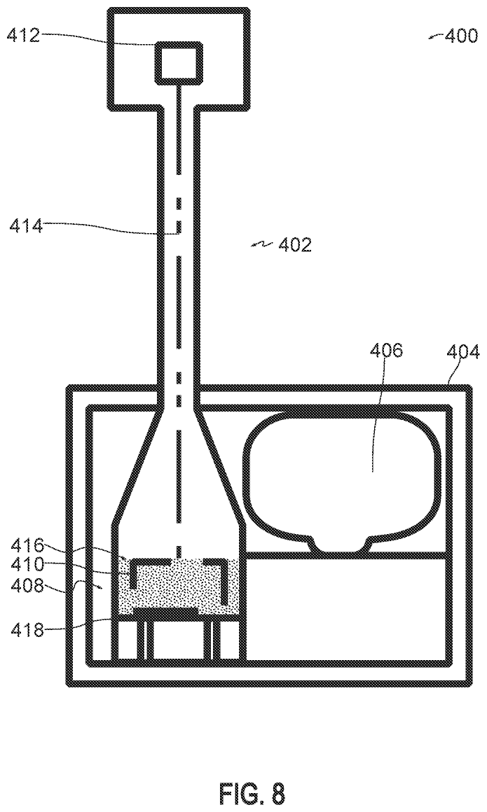

In some instances, the system 100 is coupled to an additive manufacturing device, such as the device described with reference to FIG. 8 below. The graphene-aluminum composite powder output 108 can couple the devices such that they include a shared inert environment for one or more desired fractions 126A, 126B, 126C of the powder that are conveyed directly from the system to the additive manufacturing device. Additionally, or alternatively, the fractions 126A, 126B, 126C may be conveyed into a container within the inert environment, which can then be sealed, removed from the inert environment, moved to the additive manufacturing device, and opened/accessed for use within an inert environment of the additive manufacturing device.

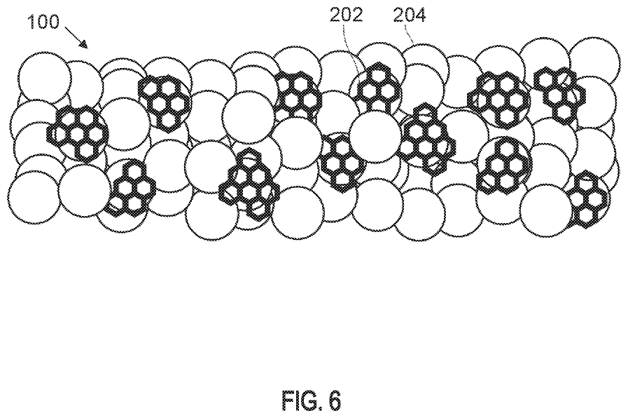

FIG. 6 illustrates an example graphene-aluminum composite powder 101 produced by the system 100. As can be seen, the graphene flakes 202 are distributed throughout the aluminum particles 204. Electrostatic or imparted charges can enhance contact between the aluminum particles 204 and planar faces of the graphene flakes 202, which reduces or eliminates interstitial voids of the powder that would otherwise result from aluminum particles 204 contacting only edges of one or more graphene flakes 202.

The avoidance of interstitial voids and the optimized contact between the aluminum particles 204 and the graphene flakes 202 enhances electrical conductivity, thermal conductivity, stability, and mechanical properties of parts (e.g., first cooling plate 18, second cooling plate 22) made from the graphene-aluminum composite powder 101. The charges may be selected to leverage the different electronic properties of the planar portions and the edge portions of the graphene flakes 202 and thereby further optimize packing and other physical properties of the powder, as well as the properties of parts formed from the powder. Beneficially, mixing of charged particles also increases graphene loading of the composite graphene-aluminum powder 101. For example, a composite graphene-aluminum powder formed from mixing charged particles may result in a graphene loading between 30 vol. % and 40 vol. %, which is above an expected loading between 20 vol. % and 25 vol. % for mixing the same particles without charges.

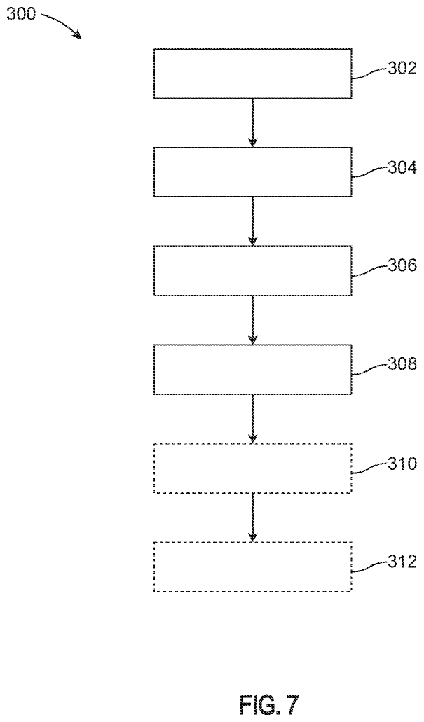

FIG. 7 illustrates a method 300 of producing the graphene-aluminum composite powder 101 illustrated in FIG. 6. At block 302, the method includes providing an inert environment. A first mist, such as atomized aluminum particles 204 with a negative charge, and a second mist, such as graphene flakes 202 with a positive charge in a solvent, are introduced to the environment in block 304 and block 306. The first mist and the second mist are provided with opposing charges such that, when mixed, aluminum particles 204 in the first mist are attracted to planar surfaces on the graphene flakes 202 in the second mist. The method 300 further includes mixing the first mist and the second mist to produce the graphene-aluminum composite powder 101 at block 308. The method 300 may also include an optional step 310 of separating or filtering the produced powder into a plurality of fractions 126A, 126B, 126C having known particle size distributions with known area fractions or volume fractions of graphene flakes 202 and aluminum particles 204. It is contemplated that the area fractions or volume fractions for each of the plurality of fractions may be different. The method 300 may also include an optional step 312 of feeding a first fraction of the plurality of fractions 126A, 126B, 126C into an additive manufacturing device coupled to the inert environment.

FIG. 8 illustrates an example additive manufacturing device 400 (e.g., a forming device). The additive manufacturing device 400 is configured to form parts (e.g., the first cooling plate 18 and/or the plurality of second cooling plates 22) using the graphene-aluminum composite powder 101 via a layer-on-layer process. The additive manufacturing device 400 includes a sintering device 402, a chamber 404, a powder supply 406, and a powder bed 408.

The sintering device 402 is configured to selectively form coherent portions within the graphene-aluminum composite powder 101 when the graphene-aluminum composite powder 101 is exposed to the sintering device 402. The selective formation of coherent portions produces a resulting graphene-aluminum composite part 410 (e.g., the first cooling plate 18 and/or the plurality of second cooling plates 22) such that the enhanced contact between the graphene flakes 202 and aluminum particles 204 of the graphene-aluminum composite powder 101 is maintained in the resulting graphene-aluminum composite part 410.

In the illustrated figure, the sintering device 402 is an electron gun 412 that emits a beam 414 of electrons. The electron beam 414 is shaped and targeted at a focal point corresponding to an upper surface 416 of the powder bed 408 such that the electron beam 414 fuses a volume of the graphene-aluminum composite powder 101 to produce a layer of the resulting graphene-aluminum composite part 410 (e.g., a first cooling plate 18, a second cooling plate 22).

The chamber 404 includes an inert environment therein. The inert environment may employ the same inert gas of the system or may employ a different inert gas. Additionally, or alternatively, the inert environment may be an ultra-low pressure environment. Further, the chamber 404 includes the powder supply 406 and the powder bed 408 within the inert environment.

The powder supply 406 is configured to maintain the graphene-aluminum composite powder 101 in an inert environment and feed it to the additive manufacturing device 400 for use in the powder bed 408. While the illustrated powder supply 406 is a container within the inert environment of the chamber 404, it is contemplated that the container or other conveyance mechanism may be connected to the outside of the chamber 404 without exposing the graphene-aluminum composite powder 101 to a non-inert environment.

The powder bed 408 includes a platform 418 that is movable relative to the sintering device 402. In the illustrated embodiment, the platform 418 is configured to move in three dimensions using a Cartesian coordinate system. It should be appreciated that other platform systems may be used. The powder bed 408 is configured to contain an amount of the graphene-aluminum composite powder 101 that moves therewith.

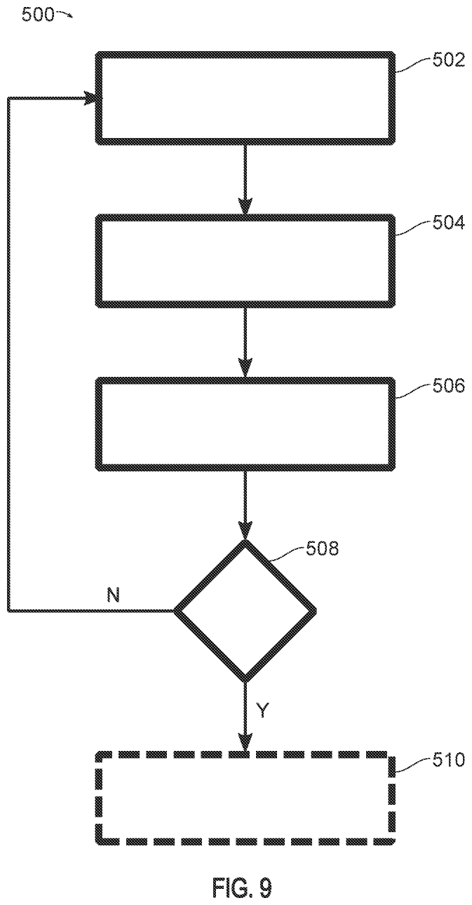

FIG. 9 illustrates a flowchart illustrating a process 500 for producing a graphene-aluminum composite part 410 (e.g., a first cooling plate 18, a second cooling plate 22) from the graphene-aluminum composite powder 101. The process 500 begins at block 502 by feeding an amount of the graphene-aluminum composite powder 101 onto a substrate. Next, at block 504, the amount of the graphene-aluminum composite powder 101 is prepared for sintering. The preparing step may include, for example, drying the amount of the graphene-aluminum composite powder 101, bringing the amount of the graphene-aluminum composite powder 101 to a predetermined temperature or temperature profile, and/or treating a surface 416 of the graphene-aluminum composite powder 101 to enhance sintering or exposure to the sintering device 402. The surface treatment can include, for example, chemical or mechanical treatment.

Block 506 of the process 500 includes exposing the surface 416 of the powder bed 408 to the sintering device 402 while translating the powder bed 408. The powder bed 408 is translated in one or more dimensions and at one or more speeds such that the portions of the graphene-aluminum composite powder 101 that are exposed to the sintering device 402 form one or more features of a cross-sectional layer of the resultant part.

After the desired features of the layer are formed, block 508 of the process 500 includes determining whether the part is complete. If the part is determined to not be complete, the platform 418 is moved such that an additional layer of the resultant part may be formed and coupled to the prior layer. The process 500 then repeats blocks 502, 504, and 506 by feeding another amount of the graphene-aluminum composite powder 101 onto the substrate atop the prior layer, preparing the graphene-aluminum composite powder 101 for sintering, and exposing the respective layer to the sintering device 402 while translating the powder bed 408 to form one or more features of that respective cross-sectional layer. This is repeated until all desired features of all desired layers of the part are formed.

Optionally, block 510 of the process 500 may include a step of further processing or treating the formed part to produce a finished graphene-aluminum composite object having desired mechanical, thermal, and/or electronic properties. For example, hot pressing or annealing may be employed to optimize inter-layer adhesion and/or optimize grain boundaries and other material properties of the formed part. Additionally, or alternatively, the substrate may be a sacrificial substrate that is removed from the formed part through mechanical processes, chemical treatments, heat or light exposure, combinations thereof, and the like.

While the present disclosure discusses additive manufacturing using the graphene-aluminum composite powder 101, it is contemplated that other powder metallurgy forming devices and techniques may be used to produce graphene-aluminum composite parts (e.g., first cooling plate 18, second cooling plate 22) using the graphene-aluminum composite powder 101.

The present disclosure has many advantages and benefits over prior art cooling plates. For example, using a graphene-aluminum composite powder to form the first cooling plate 18 and the plurality of second cooling plates 22 provides a higher thermal conductivity compared to cooling plates formed only of aluminum or aluminum alloys. Efficient heat removal facilitated by the graphene-aluminum cooling plates benefits battery range in an electric vehicle and reduces overall vehicle battery weight. Additionally, utilizing cooling plates formed of graphene-aluminum instead of conventional aluminum or aluminum alloys increases strength of the cooling plates and prevents grain growth in the cooling plates under operating temperatures (e.g., 50° C.-100° C.) due to long term operation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery pack assembly, comprising:
a battery pack enclosure including a floor and a plurality of side walls;
a first cooling plate supported by the floor within the battery pack enclosure, wherein the first cooling plate is formed of graphene aluminum composite, and wherein the first cooling plate includes:
a first planar wall and a second planar wall;
a first coolant inlet port and a first coolant outlet port disposed along an edge of the first planar wall and the second planar wall;
a first coolant volume defined by the first planar wall and the second planar wall; and
at least one first coolant flow path defined by and extending through the first coolant volume between the first coolant inlet port and the first coolant outlet port;
a plurality of battery cells supported by the first cooling plate, wherein the first cooling plate is disposed between the floor of the battery pack enclosure and the plurality of battery cells; and
a plurality of second cooling plates, wherein each one of the plurality of second cooling plates is disposed between each of the plurality of battery cells, wherein each of the plurality of second cooling plates is formed from graphene aluminum composite, and wherein each of the plurality of second cooling plates includes:
a third planar wall and a fourth planar wall;
a second coolant inlet port and a second coolant outlet port disposed along an edge of the third planar wall and the fourth planar wall;
a second coolant volume defined by the third planar wall and the fourth planar wall; and
at least one second coolant flow path extending through the second coolant volume between the second coolant inlet port and the second coolant outlet port.

2. The battery pack assembly of claim 1, wherein the first coolant flow path extends through the first cooling plate in a serpentine configuration.

3. The battery pack assembly of claim 1, wherein the plurality of battery cells includes at least one prismatic battery cell.

4. The battery pack assembly of claim 1, wherein each one of the plurality of battery cells is oriented perpendicular to the first cooling plate.

5. The battery pack assembly of claim 1, wherein each one of the plurality of second cooling plates is between 0.5 and 5 millimeters in thickness.

6. The battery pack assembly of claim 1, wherein each one of the plurality of second cooling plates is oriented perpendicular to the first cooling plate.

7. A method, comprising:
providing an inert environment;
introducing a first mist to the inert environment, the first mist being atomized aluminum with a negative charge;
introducing a second mist to the inert environment, the second mist including graphene flakes with a positive charge; and
mixing the first mist and the second mist within the inert environment to thereby produce a graphene-aluminum composite powder.

8. The method of claim 7, further comprising:
separating the graphene-aluminum composite powder into a plurality of fractions within the inert environment using at least one mesh screen.

9. The method of claim 8, further comprising:
feeding a first fraction of the plurality of fractions into an additive manufacturing device coupled to the inert environment.

10. The method of claim 7, wherein the first mist is formed from aluminum melt fed into the inert environment through a high-pressure nozzle.

11. The method of claim 7, wherein a process pressure of the inert environment includes a vacuum.

12. The method of claim 7, wherein aluminum particles of the graphene-aluminum composite powder are aluminum nanoparticles.

13. The method of claim 7, wherein the graphene flakes are formed via electrochemical exfoliation.

14. The method of claim 7, further comprising:
forming a graphene-aluminum composite first cooling plate and a graphene-aluminum composite second cooling plate using at least one of additive manufacturing or a powder metallurgy process.

15. A graphene-aluminum composite powder formed by the method of claim 7.

16. A system, comprising:
a chamber containing an inert environment and a mixing portion, the mixing portion being within the inert environment;
a first nozzle and a second nozzle, wherein the first nozzle is configured to introduce a first mist into the mixing portion of the inert environment, the first mist being atomized aluminum and having a negative charge, and wherein the second nozzle is configured to introduce a second mist into the mixing portion of the inert environment, the second mist including graphene flakes and having a positive charge; and
an output configured to convey a graphene-aluminum composite powder from the inert environment, the graphene-aluminum composite powder being formed from mixing of the first mist of negatively charged atomized aluminum and the second mist of positively charged graphene flakes.

17. The system of claim 16, wherein the first nozzle is a high-pressure nozzle.

18. The system of claim 16, wherein aluminum particles of the graphene-aluminum composite powder include aluminum nanoparticles.

19. The system of claim 16, further comprising:
at least one mesh screen configured to separate the graphene-aluminum composite powder into a plurality of fractions within the inert environment.

20. The system of claim 16, further comprising:
a forming device configured to form at least one of a graphene-aluminum composite first cooling plate or a graphene-aluminum composite second cooling plate using at least one of an additive manufacturing or a powder metallurgy process.
